(19) United States
(12) Patent Application Publication
(10) Pub. No.: US 2010/0157357 A1
(43) Pub. Date: Jun. 24, 2010

(54) IMAGE PRINTING APPARATUS HAVING CLUSTER PRINTING FUNCTION, IMAGE PRINTING SYSTEM AND IMAGE PRINTING METHOD

(75) Inventor: Keiko Torikoshi, San Mateo, CA (US)

Correspondence Address: BUCHANAN, INGERSOLL & ROONEY PC, POST OFFICE BOX 1404, ALEXANDRIA, VA, 22313-1404, US

(73) Assignee: Konica Minolta Systems Laboratory, Inc., Foster City, CA (US)

(21) Appl. No.: 12/342,696

(22) Filed: Dec. 23, 2008

(51) Int. Cl. G06F 3/12

(52) U.S. Cl. 358/1.15

(57) ABSTRACT

An image printing apparatus includes an image printing unit which prints an image and has a cluster printing function in which a print job is shared with at least one other printing apparatus over a network. A registration unit registers in the memory unit paper type information of a recording sheet to be used in the print job. A communication unit receives over the network paper type information of recording sheets in each of the plurality of other image printing apparatuses. A determination unit selects at least one candidate image printing apparatus from among the plurality of other image printing apparatus based whether the paper type information received by the communication unit matches the paper type information registered in the memory unit. The image printing apparatus, during cluster printing, shares the print job with the at least one candidate image printing apparatus.

### BACKGROUND

1. Field of the Invention

The present invention relates to an image printing apparatus, an image printing system and an image printing method having a cluster printing function which allows the image printing apparatus to share a print job with at least one of a plurality of other image printing apparatuses over a network.

2. Description of Related Art

Recent advances in advanced information technology, digitization and coupling of image printing apparatuses such as copying machines, printers, and multifunctional devices have produced a tandem output system. According to such a system, at least two image printing apparatuses are coupled to each other to quickly copy the document image read by one of the apparatuses, or a plurality of printers are made to quickly output the image data transmitted from a computer so as to obtain many image outputs within a short period of time. In this tandem output system, set contents (a paper size, density, magnification and the like) for image printing are shared among the image printing apparatuses to obtain the same output contents. An image printing apparatus serving as a master apparatus transmits set contents to image printing apparatuses serving as sub-apparatuses to allow them to share the set values. On the sub side, upon receiving the above set contents, settings are performed in the receiving apparatus. For instance, image printing is performed on the sub side upon selecting a recording sheet matching the transmitted set sheet size. Therefore, the master apparatus and the sub-apparatuses prepare recording sheets of the same size.

There is also known an image printing system which transmits paper type information of recording sheets as the above set content, and if the received paper type information of recording sheets differs from the paper type of recording sheets to be used, the system corrects image quality on the basis of the difference, thereby suppressing an image quality change due to the paper type of recording sheets and reducing the difference between print results (see Japanese Unexamined Patent Publication No. 2003-271017).

Various types of recording sheets which differ in paper type, thickness, and the like have been used for printed materials. A given printer selectively uses such recording sheets in accordance with customer needs. In order to shorten the time required for image printing, a tandem output system is used to print by using a plurality of apparatuses that are initially coupled together. If a recording sheet is determined only on the basis of a paper size, a desired image cannot be obtained. In a system designed to output images on different types of recording sheets upon image correction, different image printing apparatuses output different types of recording sheets, and hence print results inevitably differ. With the growing importance of improving print results, there is a problem that print quality declines when images are output to different types of recording sheets.

U.S. Patent Application Publication No. 2006/0262377 A1 to Kamata et al. discloses a tandem image printing apparatus and method in which a master printing apparatus is connected in tandem to one or more sub-apparatuses. The master printing apparatus includes a communication device that communicates with the sub-apparatuses so as to operate with the sub-apparatuses in a tandem output mode. A comparison and determination device compares the information of recording sheets which can be fed from the paper feed unit with paper size information and paper type information of the sub-apparatuses in the tandem output mode. The comparison and determination device determines a paper size match/mismatch and a paper type match/mismatch. A mismatch notification device notifies that a mismatch exists when one or both of the paper size and the paper type exhibits a mismatch upon receiving a determination result from the comparison and determination device. However, in the tandem output system, the master apparatus and the sub-apparatuses are initially coupled with each other so that the master apparatus does not have the option of searching for other available sub-apparatuses over a network if the initially paired sub-apparatuses do not include the set contents (a paper size, density, type and magnification) sought by the master apparatus.

JP 2003-252466 discloses a paper tray with a dial by which a user can set the type of paper accommodated in the tray. When printing, the type of paper specified in the print job is checked and appropriate paper tray is selected to feed paper from the selected paper tray.

### SUMMARY

The present invention has been made in consideration of the above issues, and provides an image printing apparatus having a cluster printing function which allows the image printing apparatus to share a print job with at least one candidate image printing apparatus from among a plurality of other image printing apparatuses over a network, and an image printing system and an image printing method which can reliably output images onto recording sheets of the same type. The cluster printing function allows the image printing apparatus to share a print job with one or more other image printing apparatuses over a network in order to output the print job in a shorter amount of time than if only one image printing apparatus was used to output the print job. According to the disclosed embodiments, the cluster printing function can be performed quickly and efficiently with at least one candidate image printing apparatus without mixing recording sheets of different types.

According to a preferred embodiment, there is provided an image printing apparatus comprising a memory unit, an image printing unit which prints an image and has a cluster printing function in which a print job is shared with at least one other printing apparatus over a network, and a registration unit which registers in the memory unit paper type information of a recording sheet to be used in the print job. The image printing apparatus further comprises a communication unit which transmits and receives image data to and from a plurality of other image printing apparatuses over the network, thereby allowing the image printing apparatus during the cluster printing function to share the print job with at least one of the plurality of other image printing apparatuses over the network, and which receives over the network paper type information of recording sheets in each of the plurality of other image printing apparatuses, and a determination unit that selects at least one candidate image printing apparatus from among the plurality of other image printing apparatus based whether the paper type information received by the communication unit matches the paper type information registered in the memory unit. The image printing apparatus, during cluster printing, shares the print job with the at least one candidate image printing apparatus.

The image printing apparatus according to the preferred embodiment searches a network to find at least one candidate image printing apparatus with which to share a cluster printing job. The search may be based on the paper type of recording sheets in each of a plurality of other image printing apparatuses on the network. The other image printing apparatuses on the network that do not have recording sheets matching the paper type sought by the initial image printing apparatus drop out from being a candidate. Once a candidate image printing apparatus having the matching paper type is found, the image printing apparatus can share the cluster printing job with the candidate image printing apparatus without mixing recording sheets of different paper types. Accordingly, the mixing of different types of paper in a cluster print job can be avoided. Thus, the outputted print job has a uniform finish and appearance. Further, the cluster printing job can be output in a shorter amount of time than if only one image printing apparatus was used to output the print job.

According to the embodiment described above, the image printing apparatus may further comprise a scanning unit which scans a recording sheet to determine a paper type of the recording sheet to be used in the print job, and which forwards the paper type information to the registration unit.

According to the embodiment described above, the paper type determined by the scanning unit is based on at least one of color, brightness and chroma.

According to the embodiment described above, the image printing apparatus further comprises a paper feed unit which comprises a plurality of paper feed trays. The paper feed unit allows a selected paper feed tray to feed a recording sheet to the image printing unit. In addition, the image printing apparatus comprises a sensor associated with each of the plurality of paper feed trays. Each sensor determines a paper type of a recording sheet in an associated paper feed tray.

According to the embodiment described above, the determination unit compares the paper type determined by each sensor with the paper type information registered in the memory unit, and selects a paper feed tray having a paper type matching the paper type information registered in the memory unit as the selected paper feed tray to feed the recording sheet.

According to the embodiment described above, the determination unit issues an alert if the paper type of the recording sheets in all of the paper feed trays does not match the paper type information registered in the memory unit.

According to the aspect described above, each sensor is provided on the associated paper tray.

According to the embodiment described above, the image printing apparatus comprises a sensor provided in a feed path of the recording sheet, the sensor determining a paper type of a recording sheet in the feed path to thereby determine the paper type of recording sheets in the paper feed tray from which the recording sheet was fed.

According to another embodiment, there is provided an image printing system comprising a network, a primary image printing apparatus, a plurality of secondary image printing apparatuses connected to the primary image printing apparatus via the network, and a cluster printing function in which a print job of the primary image printing apparatus is shared with at least one of the secondary apparatuses over the network. The primary image printing apparatus is controlled to register information of a paper type of recording sheets in the primary image printing apparatus, transmit and receive image data to and from the plurality of secondary image printing apparatuses over the network, and receive paper type information of recording sheets in each of the plurality of secondary image printing apparatuses, select at least one candidate image printing apparatus from among the plurality of secondary image printing apparatuses based whether the paper type information received from the plurality of secondary image printing apparatuses matches the registered paper type information, and during cluster printing, share the print job with the at least one candidate image printing apparatus.

This embodiment may incorporate the various aspects of the preferred embodiment described above.

According to a further embodiment, there is provided an image printing method comprising determining a paper type of a recording sheet to be used in a print job, registering paper type information in a memory unit of the primary image printing apparatus, transmitting image data to a plurality of secondary image printing apparatuses over a network to allow the primary image printing apparatus during a cluster printing function to share the print job with at least one of the plurality of secondary image printing apparatuses over the network, receiving via the network paper type information of recording sheets in each of the plurality of other image printing apparatuses, selecting at least one candidate image printing apparatus from among the plurality of secondary image printing apparatus based whether the paper type information received from the plurality of secondary image printing apparatuses matches the paper type information registered in the memory unit of the primary image printing apparatus, and sharing the print job between the primary image printing apparatus and the at least one candidate image printing apparatus.

This further embodiment may incorporate the various aspects of the embodiments described above.

Other subsidiary aspects of the present invention will be described below.

The image printing apparatus, system and method are more specifically described in the following paragraphs by reference to the drawings attached only by way of example.

### BRIEF DESCRIPTION OF THE DRAWINGS

A more complete appreciation of the present invention, and many other attendant features and advantages thereof, will become readily apparent as the same becomes better understood by reference to the following detailed description when considered in conjunction with the accompanying drawings in which like reference symbols and reference numerals indicate the same or similar components, wherein:

FIG. 1 is a schematic front view showing the overall arrangement of an image printing apparatus according to an embodiment of the present invention;

FIG. 2 is a simplified network connection diagram according to an image printing system;

FIG. 3 is a more detailed network connection diagram including a functional block diagram of the image printing apparatuses; and

FIG. 4 is a flowchart showing a sequence for a cluster printing operation in accordance with a cluster printing method.

### DETAILED DESCRIPTION OF PREFERRED EMBODIMENTS

A preferred embodiment of an image printing apparatus of the present invention will be described below with reference to the accompanying drawings.

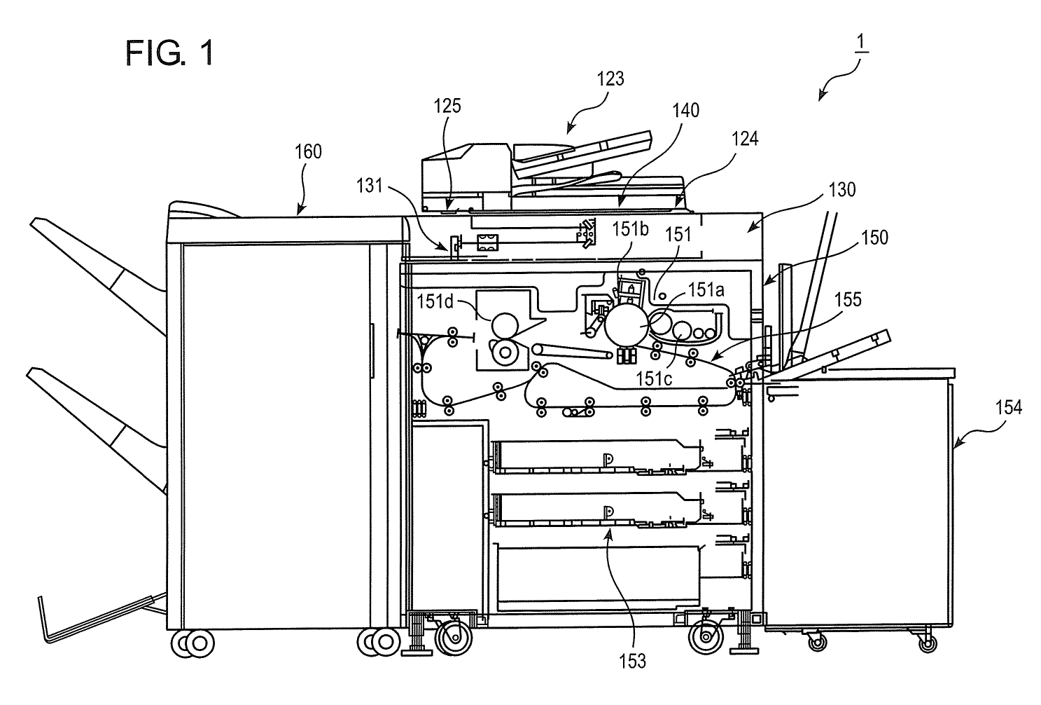

FIG. 1 schematically shows the mechanical structure of an image printing apparatus 1. The mechanical structure of the image printing apparatus 1 will be described below with reference to FIG. 1.

On the upper side of the image printing apparatus 1, there are provided a scanning unit 130 including a CCD 131, an automatic document feeder (ADF) 123, a platen glass 124 on which a document is set, and an ADF document read slit glass 125. These components constitute a document reading unit. In addition, on the upper side of the image printing apparatus 1, an operation unit 140 is provided, at a position where the platen glass 124 is not located, to allow an operator to operate the image printing apparatus 1.

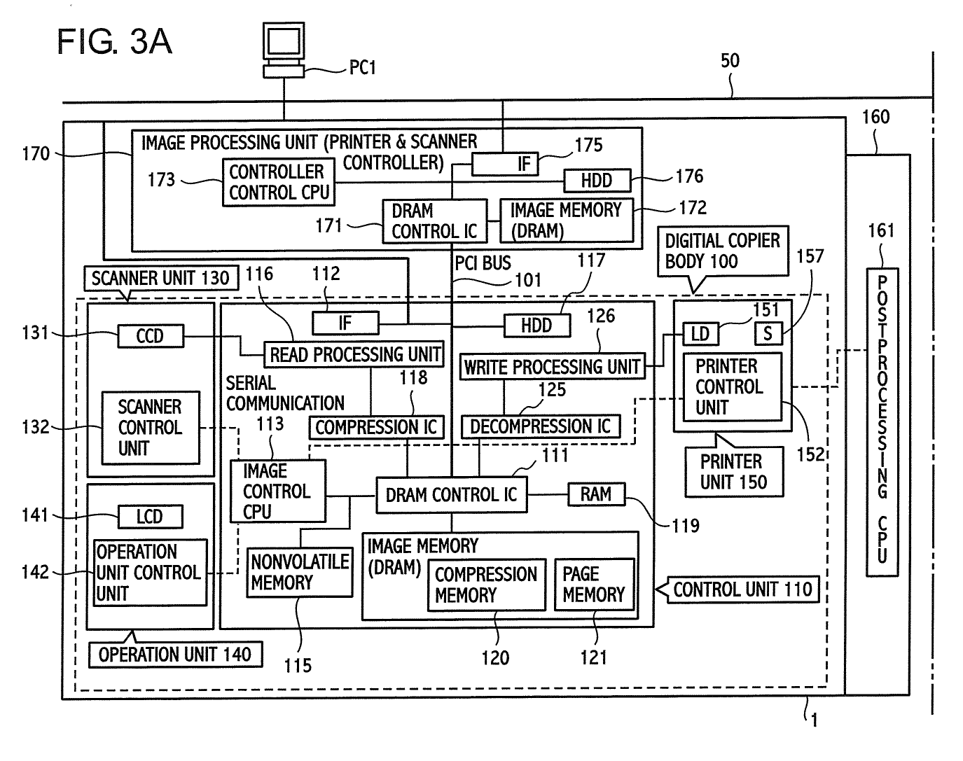

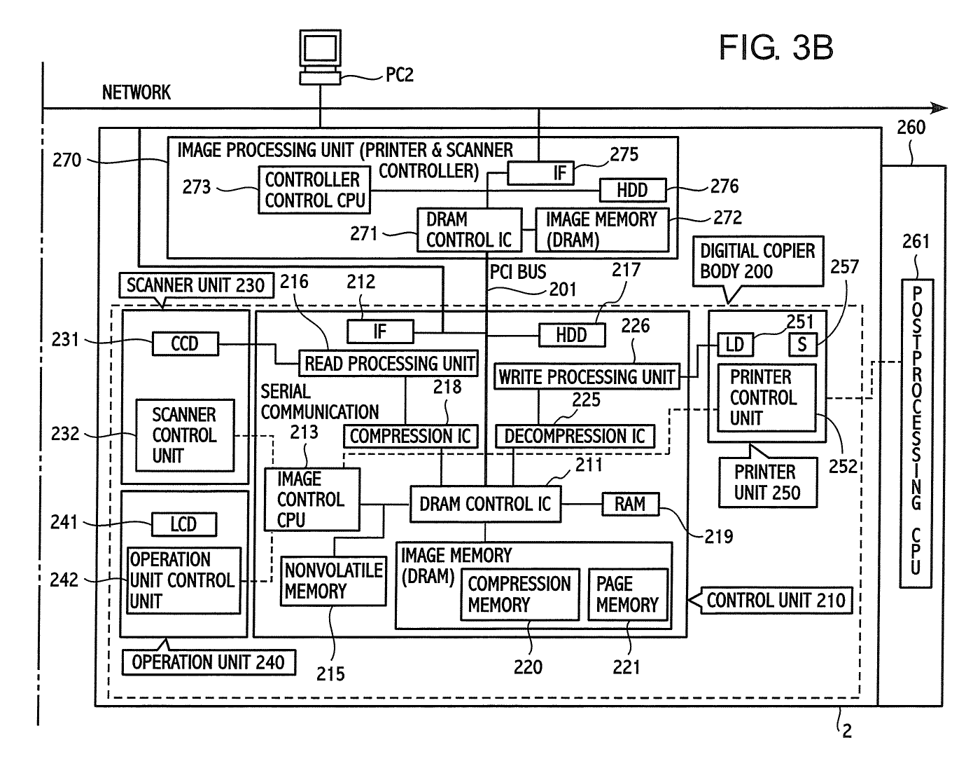

On the lower side of the image printing apparatus 1, there are provided first to third paper feed trays 153, and a large-capacity paper feed tray 154 which is additionally attached to the image printing apparatus 1. Feed rollers 155 are provided at a location where recording sheets are conveyed from the paper feed trays 153, 154. These components constitute a paper feed unit according to this embodiment. An image printing unit comprising an LD (Laser Diode) 151 and the like is provided downstream in the convey direction of the feed rollers 155. A printer unit 150 is constituted by the above image printing unit, the first to third paper feed trays 153, the large-capacity paper feed tray 154, the feed rollers 155, and the like. The above image printing unit comprises a photosensitive body 151a, a charger 151b, a developing device 151c, a fixing device 151d, and the like. A sensor 157 (see FIG. 3) may be associated with each of the plurality of paper feed trays 153, 154. That is, each of the plurality of paper feed trays 153, 154 may have a sensor 157. On the downstream side of the image printing unit, a postprocessing apparatus (FNS) 160 is installed in a delivery area to perform desired postprocessing (stapling, punching, or the like) for recording sheets on which an image are printed.

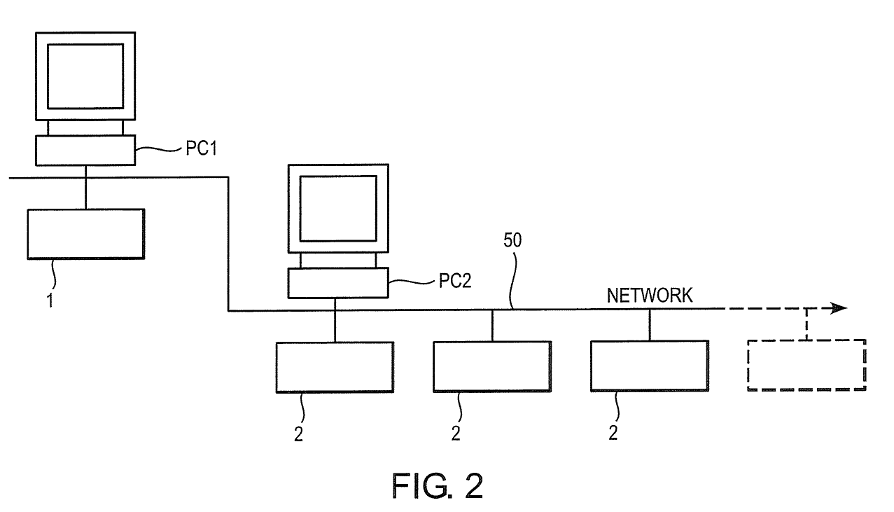

FIG. 2 shows a network connection diagram including the image printing apparatus 1 as a primary image printing apparatus in an image printing system. The primary image printing apparatus 1 is connected to terminal apparatus PC1 serving as an external processing apparatus. The primary image printing apparatus 1 is further connected to a plurality of secondary image printing apparatuses 2 via a network 50 to allow a cluster printing operation between the primary image printing apparatus 1 and one or more of the secondary image printing apparatuses 2. Although FIG. 2 shows three image printing apparatuses as the secondary image printing apparatuses 2, the number of secondary image printing apparatuses 2 is not specifically limited, and may comprise more or less secondary image printing apparatuses. In addition, although FIG. 2 shows only one of the secondary image printing apparatuses 2 being connected to a terminal apparatus PC2, more of the secondary image printing apparatuses may also be connected to a respective terminal apparatus. Alternatively, none of the secondary image printing apparatuses may be connected to a terminal apparatus. The network 50 may be a local area network (LAN). However, the structure of the network 50 is not limited to the LAN as long as the network 50 is a communication path capable of sending and receiving the data. For example, the network 50 may be a communication using the internet or the like, or may be a dedicated line.

FIG. 3 shows the primary image printing apparatus 1 and the secondary image printing apparatus 2 as functional blocks. As shown in FIG. 3, the primary image printing apparatus 1 comprises a digital multifunctional machine, and the secondary image printing apparatus 2 is connected to the primary image printing apparatus 1 through the network 50. Note that the secondary image printing apparatus 2 may also have the same mechanical arrangement as the primary image printing apparatus 1. The details of these apparatuses will be described below.

As shown in the block diagram of FIG. 3, the image printing apparatuses 1 and 2 respectively comprise digital copier bodies 100 and 200 respectively including control units 110 and 210, scanner units 130 and 230, operation units 140 and 240, printer units 150 and 250, and image processing units 170 and 270 which process image data input/output from/to the outside through the network 50.

The control units 110 and 210 of the digital copier bodies 100 and 200 respectively include network interfaces 112 and 212 connected to the network 50 as described above, and are connected to DRAM control ICs 111 and 211 through PCI buses 101 and 201 inside the image printing apparatuses 100 and 200. In addition, the control units 110 and 210 respectively comprise image control CPUs 113 and 213 which control the overall image printing apparatuses. The DRAM control ICs 111 and 211 are connected to the image control CPUs 113 and 213.

Nonvolatile memories 115 and 215 are respectively connected to the image control CPUs 113 and 213. Programs for operating the image control CPUs 113 and 213, set data for the primary and secondary image printing apparatuses 1 and 2, and data such as process control parameters are stored in the nonvolatile memories 115 and 215. In addition, the specified data of paper type information can be stored in the nonvolatile memories 115 and 215. The data concerning the paper type information of recording sheets in the paper feed unit can also be stored in the nonvolatile memories 115 and 215. The nonvolatile memories 115 and 215 may function as recording sheet information registration units and paper feed/recording sheet information registration units.

RAMs 119 and 219 are respectively connected to the DRAM control ICs 111 and 211. The RAMs 119 and 219 serve as temporary storage of data and as work areas for programs. Large-capacity HDDs 117 and 217 are respectively connected to the DRAM control ICs 111 and 211 through the PCI buses 101 and 201. Image data can be stored in the HDDs 117 and 217. In addition, the above programs, set data, and the like can also be stored in these HDDs 117 and 217. Therefore, when the specified data of paper type information and paper type information of recording sheets in the paper feed units are to be stored in the HDDs 117 and 217, they function as the recording sheet information registration units and paper feed/recording sheet information registration units in this embodiment.

The image control CPUs 113 and 213 can read nonvolatile data from the nonvolatile memories 115 and 215, and can write desired data as nonvolatile data in the nonvolatile memories 115 and 215. The image control CPUs 113 and 213 can communicate with other image printing apparatuses and the like through the network 50 (pre-designated machines=IP addresses), and can transmit/receive image data, set parameters, and paper type information to/from other image printing apparatuses. That is, the network interfaces 112 and 212 function as communication units in this embodiment. The image control CPUs 113 and 213 can exchange data with the nonvolatile memories 115 and 215, and can further exchange data with other image printing apparatuses through the network interfaces 112 and 212. Upon exchanging the above data, the image control CPUs 113 and 213 can determine a paper type match by comparing the paper type information received through the network interfaces 112 and 212 with the paper type information stored in the nonvolatile memories 115 and 215. The image control CPUs 113 and 213 may therefore function as comparison and determination units.

When image information is to be output, the image control CPU 113 can assign output operations to the plurality of secondary image printing apparatuses 2 and issue a cluster output instruction to each secondary image printing apparatus 2. That is, the cluster printing operation functions in accordance with the operations of the image control CPU 113.

The scanner units 130 and 230 comprise CCDs 131 and 231 which perform optical reading, and scanner control units 132 and 232 which perform overall control on the scanner units 130 and 230. The scanner control units 132 and 232 are connected to the image control CPUs 113 and 213 so as to allow serial communication. The CCDs 131 and 231 are also connected to read processing units 116 and 216 which process the image data read by the CCDs 131 and 231. Compression ICs 118 and 218 which compress image data are respectively connected to the read processing units 116 and 216. The compression ICs 118 and 218 are respectively connected to the DRAM control ICs 111 and 211 described above. Image reading units are respectively constituted by the scanner units 130 and 230, read processing units 116 and 216, compression ICs 118 and 218.

The operation units 140 and 240 respectively comprise LCD touch panels 141 and 241 as input units, and operation unit control units 142 and 242. The LCD touch panels 141 and 241 are respectively connected to the operation unit control units 142 and 242, which are, in turn, respectively connected to the image control CPUs 113 and 213. The operation units 140 and 240 can display settings, input information such as operation commands, set contents, and the like in the primary and secondary image printing apparatuses 1 and 2. That is, the operation units 140 and 240 can input various kinds of settings, recording sheet information, changes, and recording sheet information in the paper feed units, and change such information. The operation units 140 and 240 therefore also function as recording sheet information registration units, recording sheet information changing units, paper feed/recording sheet information registration units, paper feed/recording sheet information changing units, and paper feed setting units. The operation units 140 and 240 allow selection of paper feed trays, in the paper feed units, which can perform a paper feeding operation. The operation units 140 and 240 therefore also function as paper feed tray selection input units.

The LCD touch panels 141 and 241 may function as display units, which display necessary information and allow operators to recognize the information. Therefore, the LCD touch panels 141 and 241 may also function as paper feed/recording sheet information selection units which register paper feed/recording sheet information while referring to registered recording sheet information.

Input results obtained by using the operation units 140 and 240 are output to the image control CPUs 113 and 213, and predetermined processing is then performed in accordance with the input contents. The image control CPUs 113 and 213 implement partial functions of the respective units in cooperation with the operation units 140 and 240.

The DRAM control ICs 111 and 211 are connected to image memories comprising compression memories 120 and 220 and page memories 121 and 221. Decompression ICs 125 and 225 which decompress compressed image data are respectively connected to the DRAM control ICs 111 and 211. Write processing units 126 and 226 are respectively connected to the LD (Laser Diode) 151 and an LD (Laser Diode) 251 of the printer units 150 and 250 to process data used for the operations of the LDs 151 and 251. The printer units 150 and 250 respectively comprise printer control units 152 and 252 which control the overall printer units 150 and 250. The printer control units 152 and 252 are respectively connected to the image control CPUs 113 and 213. Postprocessing CPUs 161 and 261 which control the postprocessing apparatus (FNS) 160 and a postprocessing apparatus 260 are respectively connected to the printer control units 152 and 252. The postprocessing apparatuses 160 and 260 are controlled through the printer control units 152 and 252.

DRAM control ICs 171 and 271 of the image processing units 170 and 270 are respectively connected to the DRAM control ICs 111 and 211 through the PCI buses 101 and 201. In the image processing control units 170 and 270, image memories 172 and 272 are respectively connected to the DRAM control ICs 171 and 271. In addition, in the image processing control units 170 and 270, the DRAM control ICs 171 and 271, controller control CPUs 173 and 273, hard disk drives 176, 276 and network interfaces 175 and 275 are connected to a common bus. The network interfaces 175 and 275 are connected to the network 50.

A sequence of storing image data in the image printing apparatus 1 will now be described with reference to the arrangement of the image printing apparatus 1.

In the embodiment, the scanner unit 130 reads an image to generate image data. In the scanner unit 130, the CCD 131 optically reads an image from a document. In this case, the operation of the CCD 131 is controlled by the scanner control unit 132 which receives a command from the image control CPU 113. The image control CPU 113 operates in accordance with a computer/software program, and issues a command to the scanner unit 130 on the basis of operation by the operator using the operation unit 140 or the terminal apparatus PC1. The image read by the CCD 131 is subjected to data processing by the read processing unit 116. The image data having undergone the data processing is compressed by the compression IC 118 using a predetermined method. The resultant data is then stored in the compression memory 120 through the DRAM control IC 111.

Image data is not limited to only being obtained by scanning. For example, image data may also be acquired externally. Such data is stored in the image memory 172 through the network 50 and the DRAM control IC 171. This data is received by the image processing unit 170 of the image printing apparatus 1 through the network interface 175, and is stored in the image memory 172 by the DRAM control IC 171. The data in the image memory 172 is sequentially sent to the compression IC 118 through the DRAM control IC 171, PCI bus 101, and DRAM control IC 111, and is compressed. The compressed data is stored in the compression memory 120 through the DRAM control IC 111.

In another case, image data may be generated by an image reading operation in the secondary image printing apparatus 2, and is transmitted through the network 50. This data is received through the network interface 112 of the primary image printing apparatus 1, and is stored in the compression memory 120 through the DRAM control IC 111. The image data stored in the compression memory 120 can be transmitted to another secondary image printing apparatus 2 through the DRAM control IC 111, the network interface 112, and the network 50. In the secondary image printing apparatus 2, the image data can be received and stored, and image printing processing can also be performed with respect to the data. When image data is to be sent out to a secondary image printing apparatus 2 in a cluster printing operation, the data is sent out through the network interface 112 by the same sequence as that described above.

When an image output operation is to be performed by the image printing apparatus 1 without using the cluster printing function, i.e., the apparatus is to be used as a copying machine or printer, image data is stored in the compression memory 120 in the above manner, and the image data from the compression memory 120 is bitmapped in the page memory 121. The image data is then sent out to the decompression IC 125 through the DRAM control IC 111 to be decompressed. The decompressed data is sent out to the write processing unit 126. The LD 151 then writes the data on the photosensitive body. In addition, in the printer unit 150, upon receiving a command from the image control CPU 113, the printer control unit 152 controls the respective units. With the above operation, in the printer unit 150, an image is printed on a predetermined recording sheet, and the recording sheet is subjected to postprocessing in the postprocessing apparatus 160 under the control of the postprocessing CPU 161.

A primary image printing apparatus 1 according to the preferred embodiment will now be described. As discussed above, the primary image printing apparatus 1 includes a nonvolatile memory 115 serving as a memory unit. In some embodiments, the HDD 117 may serve as the memory unit. The memory unit stores paper type information that has been specified in advance. That is, the memory unit functions as recording sheet information registration unit. In addition, the data concerning the paper type information of recording sheets in the paper feed unit can also be stored in the memory unit (nonvolatile memory 115).

The print unit 150 includes an image printing unit which prints an image. The image printing unit has a normal printing function and a cluster printing function that allows the primary image printing apparatus 1 to print in either a normal printing mode or a cluster printing mode, respectively. The printing modes can be selectively switched as desired by the user or can be programmed to switch from one mode to the other in accordance with a predetermined set of conditions. Thus, the cluster printing function may be always active (e.g., in standby mode) or may be selectively activated by an operator. For example, the image printing unit can be programmed via appropriate software applications to automatically switch to the cluster printing mode when the print job exceeds a certain number of pages or a certain number of documents to be printed. However, the embodiment is not limited to these conditions, and other conditions may be programmed into the image printing unit. In the normal printing mode, the primary image printing apparatus 1 outputs a print job by itself, without the aid of any secondary image printing apparatuses 2. In the cluster printing mode, the primary image printing apparatus 1 searches the network 50, as described in further detail below, to locate at least one secondary image printing apparatuses 2 with which to share a print job over the network 50. The print job may be shared in accordance with the image data read by the primary image printing apparatus 1, or externally input image data. Sharing a print job over the network 50 enables the print job to be output in a shorter amount of time than if only one image printing apparatus was used to output the print job. Thus, printing time can be saved by switching the image printing unit to operate in the cluster printing mode.

The scanning unit 130 of the primary image printing apparatus 1 scans a recording sheet to determine a paper type of the recording sheets to be used in the print job. As discussed above, the scanner unit 130 comprises the CCD 131 which performs optical reading of the recording sheet. The read processing unit 116 processes the image data read by the CCD 131 to determine the paper type of the scanned recording sheet. In the embodiment, the scanning unit 130 receives a recording sheet fed directly by a user of the primary image printing apparatus 1. However, the scanning unit 130 may also be configured to select a recording sheet from one of the paper trays 153, 154 to be used as the recording sheet for the print job. After the scanning unit 130 determines the paper type to be used in the print job, the scanning unit 130 registers information of the paper type in the memory unit (nonvolatile memory 115). The memory unit stores the paper type information determined by the scanning unit 130.

However, obtaining information relating to the paper type of the recording sheet to be used in the print job is not limited to scanning. The paper type information may be obtained in advance from a pre-registered default list of paper type information stored in the HDD 117 of the primary image printing apparatus 1. Alternatively, the paper type information may be manually entered by the user using the operation unit 140 described above. In addition, the user may manually add paper type information to the default list using the operation unit 140.

Thus, registering in the memory unit paper type information of a recording sheet to be used in the print job can be performed without the scanning unit 130.

The paper feed unit of the primary image printing apparatus 1 feeds the scanned recording sheet to the image printing unit, where the scanned recording sheet can be used in the print job. However, the scanned recording sheet does not itself have to be used in the print job, and may be scanned only for the purpose of determining a paper type of recording sheets to be used in the print job.

As discussed above, the network interface 112 functions as a communication unit. The communication unit transmits and receives image data to and from the plurality of secondary image printing apparatuses 2 over the network 50. For instance, the communication unit sends and receives image data to and from the network interfaces 212 (communication units) of the secondary image printing apparatuses 2. By sending and receiving image data to and from the plurality of secondary image printing apparatuses 2, the communication unit allows the primary image printing apparatus 1 during the cluster printing function to share a print job with at least one of the secondary image printing apparatuses 2 over the network 50. Included in the information received from the secondary image printing apparatuses 2 is information of the paper type of recording sheets in each of the plurality of secondary image printing apparatuses 2.

After the communication unit receives the paper type information of the recording sheets in each of the plurality of secondary image printing apparatuses 2, the image control CPU 113, serving as a determination unit, determines whether one of the secondary image printing apparatuses 2 on the network 50 has recording sheets matching the paper type registered in the primary image printing apparatus 1. For example, the image control CPU 113 compares the paper type information received through the network interface 112 with the paper type information stored in the memory unit (nonvolatile memory 115). In this manner, the image control CPU 113 searches the network 50 for at least one candidate image printing apparatus from among the plurality of secondary image printing apparatuses 2 that has recording sheets matching the paper type stored in the memory unit (nonvolatile memory 115) of the primary image printing apparatus 1. The secondary image printing apparatuses 2 on the network 50 that do not have recording sheets matching the paper type stored in the memory unit (nonvolatile memory 115) of the primary image printing apparatus 1 drop out from being a candidate for the cluster printing job. The primary image printing apparatus 1 ceases to communicate with secondary image printing apparatuses 2 that have dropped out being a candidate for the cluster printing job.

Once a candidate image printing apparatus having matching paper type is found, the primary image printing apparatus 1 can share the cluster printing job with the candidate image printing apparatus without mixing recording sheets of different paper types in the cluster print job. Accordingly, the mixing of different types of paper in a cluster print job can be avoided. Thus, the cluster printing function can be performed quickly and efficiently without mixing recording sheets of different types, and the outputted cluster print job can have a uniform finish and appearance.

According to the embodiment described above, the paper type determined by the scanner is based on at least one of color, brightness and chroma. In other embodiments, however, the contents of a paper type to be used are not limited to any specific contents, and various different contents can be set as needed. For example, other embodiments may determine a paper type based on basis weight, the presence/absence of punched holes, and the like. Other paper type information that may be determined include ordinary paper, fine paper, coated paper, book paper, rough paper, and OHP, or a material arbitrarily set by the user as user paper.

According to the embodiment described above, the paper feed unit comprises a plurality of paper feed trays 153, 154, and allows a selected paper feed tray to feed a recording sheet during the printing operation. The selection may be based on whether the feed tray includes recording sheets having the paper type matching the paper type stored in the nonvolatile memory 115. Accordingly, the primary image printing apparatus 1 comprises sensors 157 associated with each of the plurality of paper feed trays 153, 154 to determine a paper type of the recording sheets inside the paper feed trays 153, 154. That is, each sensor 157 determines a paper type of a recording sheet in an associated paper feed tray. The sensor 157 may be an optical sensor to detect the color, brightness and chroma of a recording sheet. The optical sensor may be a transmission sensor or a reflection sensor. However, the structure of the sensor 157 is not limited to any particular type of sensor, and a sensor that can detect basis weight or other features may be used depending on the desired criteria for the paper type. The sensor 157 may be provided in the respective paper feed tray, on the respective paper feed tray, or outside of but associated with the respective paper feed tray. In an alternative embodiment, the sensor 157 may be provided in a feed path of the recording sheet, and the sensor 157 may determine a paper type of a recording sheet in the sheet feed path. The paper type of the recording sheet in the feed path is determinative of the paper type of recording sheets in the paper feed tray from which the detected recording sheet was fed.

Each paper feed tray may be a fixed type designed to select recording sheets which can be fed by a setting in advance or an APS (Automatic Paper Selection) type designed to automatically select a paper feed tray having recording sheets matching a designated paper type. Alternatively, each paper feed tray may arbitrarily switch/set the fixed type and the APS type.

According to the embodiment described above, the image control CPU 113 also compares the paper type determined by each sensor 157 with the paper type information registered in the memory unit (nonvolatile memory 115), and selects a paper feed tray having a paper type matching the paper type information registered in the memory unit as the selected paper feed tray to feed the recording sheet. If the paper type of the recording sheets in all of the paper feed trays 153, 154 does not match the paper type information registered in the memory unit, the image control CPU 113 (determination unit) may issue an alert to notify the user that none of the paper feed trays 153, 154 have recording sheets that match the paper type information registered in the memory unit. The alert may be an audio alert, a visual alert or a combination thereof. The alert may be made via the operation unit 140. For example, the operation unit 140 may sound an audio alert, or a visual alert may be displayed on the LCD 141. If none of the paper feed trays 153, 154 have recording sheets that match the paper type information registered in the memory unit, the communication unit (network interface 112) may send this information to the candidate image printing apparatus and instruct the candidate image printing apparatus to perform the print job, and/or the communication unit (network interface 112) may search the network for an additional candidate image printing apparatus from among the plurality of secondary image printing apparatuses 2 to assist with outputting the print job.

As shown in FIG. 3 and discussed above, the secondary image printing apparatuses 2 may have the same mechanical arrangement as the primary image printing apparatus 1. Thus, all of the functions of the primary image printing apparatus 1 may be possessed by the secondary image printing apparatuses 2. Accordingly, each secondary image printing apparatus 2 may also serve as “primary image printing apparatus” with respect to the other secondary image printing apparatuses 2 of desired or should the need arise.

An image printing system using the imager printing apparatuses disclosed above will now be described. The image printing system may include each of the aspects of the preferred embodiment discussed above. For example, as shown in FIG. 2, the image printing system includes a network 50, a primary image printing apparatus 1 and a plurality of secondary image printing apparatuses 2 connected to the primary image printing apparatus 1 via the network 50. The first and second image printing apparatuses 1 and 2 may have the mechanical arrangements shown in FIG. 3. The system may operate according to a cluster printing mode in which a print job of the primary image printing apparatus 1 is shared with at least one of the secondary apparatuses 2 over the network 50, as discussed above according to the preferred embodiment. Thus, the different aspects of the cluster printing mode will not be repeated here.

The system controls the primary image printing apparatus 1 and secondary image printing apparatuses 2 to operate as discussed above in the preferred embodiment. That is, the image printing system may incorporate each of the features of the network 50, the primary image printing apparatus 1 and the plurality of secondary image printing apparatuses 2 disclosed above in the preferred embodiment. Thus, the various operations of the primary image printing apparatus 1 and secondary image printing apparatuses 2 will not be repeated in detail here. Note that the system may control the primary image printing apparatus 1 using the terminal apparatus PC1 serving as an external processing apparatus. Alternatively, the system may control the image printing apparatuses via the image processing units 170 and 270. In general, the system controls the primary image printing apparatus 1 to register information of a paper type of recording sheets in the primary image printing apparatus 1 via the scanning unit 130. The system controls the primary image printing apparatus 1 to transmit and receive image data to and from the plurality of secondary image printing apparatuses 2 over the network 50, and to receive paper type information of recording sheets in each of the plurality of secondary image printing apparatuses 50. In addition, the system controls the primary image printing apparatus 1 to select at least one candidate image printing apparatus from among the plurality of secondary image printing apparatuses 2 based whether the paper type information received in the from the plurality of secondary image printing apparatuses matches the registered paper type information. During cluster printing, the primary image printing apparatus 1 is controlled to share the print job with the at least one candidate image printing apparatus. Thus, the primary image printing apparatus 1 and secondary image printing apparatuses 2 operate as discussed above according to the preferred embodiment.

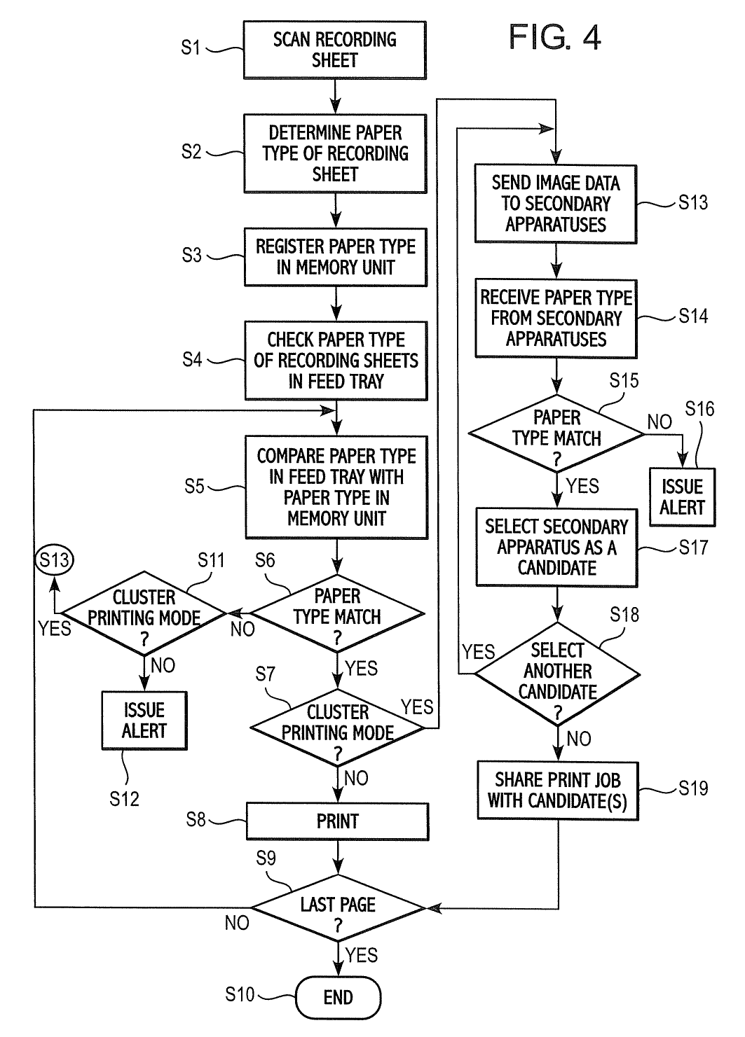

An image printing method using the above described system will now be described with respect to FIG. 4. The description is an example of the processing performed by the primary image printing apparatus 1 described above.

At step S1, a recording sheet is scanned in the primary image printing apparatus 1. The scanning is performed with the scanning unit 130. The recording sheet scanned by the scanning unit 130 may be fed directly by a user of the primary image printing apparatus 1, or may be configured to select a recording sheet from one of the paper trays 153, 154. The scanning of the recording sheet is performed to determine a paper type of the recording sheet to be used in a print job, as discussed in step S2.

At step S2, a paper type of the scanned recording sheet to be used in a print job is determined. As discussed above, the scanner unit 130 comprises the CCD 131 which performs optical reading of the recording sheet. The read processing unit 116 processes the image data read by the CCD 131 to determine the paper type of the scanned recording sheet.

At step S3, the scanning unit 130 registers information of the paper type in the memory unit (nonvolatile memory 115) of the primary image printing apparatus 1. The memory unit stores the paper type information determined by the scanning unit 130. In some embodiments, the HDD 117 may serve as the memory unit.

However, obtaining information relating to the paper type of the recording sheet to be used in the print job is not limited to scanning. For example, the paper type information may be obtained in advance from a default list of paper type information stored in the HDD 117 of the primary image printing apparatus 1. Alternatively, the paper type information may be manually entered by the user using the operation unit 140 described above. In addition, the user may manually add paper type information to the default list using the operation unit 140. Thus, steps S1-S3 in the method may be replaced by the step of accessing from the memory unit registered paper type information of a recording sheet to be used in the print job.

At step S4, the sensor 157 associated with each of the plurality of paper feed trays 153, 154 of the primary image printing apparatus 1 determines a paper type of the recording sheets in the associated paper feed tray. The paper type detected by the sensor 157 of each paper feed tray 153, 154 is representative of the paper type of the recording sheets in each of the respective paper feed trays of the primary image printing apparatus 1. As discussed above, the sensor 157 may be an optical sensor that detects the color, brightness and chroma of a recording sheet.

At step S5, the image control CPU 113 (determination unit) compares the paper type determined by each sensor 157 with the paper type information registered in the memory unit (nonvolatile memory 115) of the primary image printing apparatus 1. The process then proceeds to step S6. At step S6, the image control CPU 113 determines whether one of the paper feed trays 153, 154 has recording sheets matching the paper type information registered in the memory unit (nonvolatile memory 115) of the primary image printing apparatus 1.

If the image control CPU 113 determines that at least one of the paper feed trays 153, 154 of the primary image printing apparatus 1 has recording sheets matching the paper type information registered in the memory unit (nonvolatile memory 115) of the primary image printing apparatus 1 (YES at step S6), the process proceeds to step S7. At step S7, the image control CPU 113 determines whether the image printing unit of the primary image printing apparatus 1 is in the cluster printing mode. If the answer is YES, the process proceeds to step S13, discussed below. If the answer is NO, the image printing unit of the primary image printing apparatus 1 is in the normal printing mode, and the process proceeds to step S8. As discussed above, in the normal printing mode the primary image printing apparatus 1 outputs a print job by itself, without the aid of any secondary image printing apparatuses 2. Thus, at step S8, the print job is printed by the primary image printing apparatus 1 alone.

At step S9, the control CPU 173 in the image processing unit 170 determines whether the last page of the print job has been printed by the primary image printing apparatus 1. If the answer is YES, the process proceeds to step S10 where the process (and print job) is terminated. If the answer at step S9 is NO, the process returns to step S5, and steps S5-S9 are again executed. The process may continue in a circular manner from step S9 to step S5 until the last page of the print job is printed.

Referring back to step S6, if the image control CPU 113 determines that none of the paper feed trays 153, 154 of the of the primary image printing apparatus 1 has recording sheets matching the paper type information registered in the memory unit (nonvolatile memory 115), the process proceeds to step S11. In some embodiments of the process at step S6, the image control CPU 113 may determine whether one or a combination of the paper feed trays 153, 154 has a sufficient number of recording sheets that match the paper type information registered in the memory unit of the primary image printing apparatus 1 in order to output the entire print job. If the answer is NO, the process proceeds to step S11.

At step S11, the image control CPU 113 determines whether the image printing unit of the primary image printing apparatus 1 is in the cluster printing mode. If the answer is YES at step 11, the process proceeds to step S13, discussed below. As described above, the printing modes can be switched from one mode to the other as desired by the user or can be programmed to switch from one mode to the other in accordance with a predetermined set of conditions. That is, the image printing unit may be programmed to automatically switch to the cluster printing mode if the image control CPU 113 determines that none of the paper feed trays 153, 154 of the of the primary image printing apparatus 1 has recording sheets matching the paper type information registered in the memory unit (nonvolatile memory 115). If such is the case, the process also proceeds to step S13, discussed below.

If the answer at step S11 is NO, such that the image control CPU 113 determines that none of the paper feed trays 153, 154 of the of the primary image printing apparatus 1 has recording sheets matching the paper type information registered in the memory unit (nonvolatile memory 115), and that the primary image printing apparatus 1 is not in the cluster printing mode, the image control CPU 113 (determination unit) may issue an alert to notify the user that the print job can not be output with recording sheets having the paper type registered in the memory unit (nonvolatile memory 115). The alert may be made via the operation unit 140. For example, the operation unit 140 may sound an audio alert, or a visual alert may be displayed on the LCD 141.

If the answer at step S7 or at step S11 is YES, the image control CPU 113 determines that the image printing unit of the primary image printing apparatus 1 is in the cluster printing mode. Thus, the process proceeds to step S13. As discussed above, in the cluster printing mode the primary image printing apparatus 1 searches the network 50 to locate at least one secondary image printing apparatuses 2 with which to share the print job over the network 50. Sharing a print job over the network 50 enables the print job to be output in a shorter amount of time than if only the primary image printing apparatus 1 was used to output the print job. Thus, printing time can be saved by switching the image printing unit of the primary image printing apparatus 1 to operate in the cluster printing mode. However, to provide the outputted print job with a uniform finish and appearance, the primary image printing apparatus 1 searches for at least one secondary image printing apparatuses 2 having recording sheet of the same paper type as the type registered in the memory unit (nonvolatile memory 115) of the primary image printing apparatus 1.

Accordingly, at step S13, the network interface 112 of the primary image printing apparatus 1 transmits image data over the network 50 to a plurality of secondary image printing apparatuses 2 in order to locate at least one secondary image printing apparatuses 2 with which to share the cluster print job. The image data includes information that enables the plurality of secondary image printing apparatuses 2 to understand the requirements of the cluster print job issued by the primary image printing apparatus 1.

At step S14, the network interface 112 of the primary image printing apparatus 1 receives paper type information of recording sheets in each of the plurality of secondary image printing apparatuses 2. As discussed above, the secondary image printing apparatuses 2 may have the same mechanical arrangement as the primary image printing apparatus 1. Thus, the secondary image printing apparatuses 2 may each determine the type of recording sheets in their respective paper feed trays in the same manner as the primary image printing apparatus 1.

At step S15, the image control CPU 113 determines whether the information received from each of the plurality of secondary image printing apparatuses 2 includes data indicating that the recording sheets in at least one paper feed tray of a secondary image printing apparatus 2 matches the paper type information registered in the memory unit (nonvolatile memory 115) of the primary image printing apparatus 1. In some embodiments, the image control CPU 113 may determine whether one or a combination of secondary image printing apparatuses 2 has a sufficient number of recording sheets that match the paper type information registered in the memory unit of the primary image printing apparatus 1 in order to output the entire print job.

If the answer at step S15 is NO, such that the image control CPU 113 determines that none of the secondary image printing apparatuses 2 has recording sheets matching the paper type information registered in the memory unit (nonvolatile memory 115) of the primary image printing apparatus 1, or that none of the secondary image printing apparatuses 2, alone or in combination, has a sufficient number of recording sheets matching the paper type information registered in the memory unit of the primary image printing apparatus 1 in order to output the entire print job, the process proceeds to step S16. At step S16, the image control CPU 113 (determination unit) may issue an alert to notify the user that the print job can not be output with recording sheets having the paper type registered in the memory unit (nonvolatile memory 115). The alert may be via the operation unit 140. For example, the operation unit 140 may sound an audio alert, or a visual alert may be displayed on the LCD 141.

If the answer at step S15 is YES, such that the image control apparatus determines that the network interface 112 has received information from at least one of the plurality of secondary image printing apparatuses 2 indicating that the secondary image printing apparatus has recording sheets matching the paper type information registered in the memory unit of the primary image printing apparatus 1, the image control CPU 113 selects the at least one secondary image printing apparatuses 2 as a candidate image printing apparatus with which to share the cluster printing job.

At step S18, the image control CPU 113 determines whether an additional candidate image printing apparatuses should be included in the cluster printing job. For example, the image control CPU 113 may determine that the information received from the candidate printing apparatus indicates that the candidate printing apparatus has recording sheets matching the paper type information registered in the memory unit of the primary image printing apparatus 1, but does not have a sufficient number of matching recording sheets in order to output the entire print job. The image control CPU 113 may then search for an additional candidate image printing apparatus in order to help complete the cluster printing job. If the answer at step 18 is YES, the process returns to step S13 and steps S13-S18 are again executed. The process may continue in a circular manner from step S13 to step S18 until the desired number of candidate image printing apparatus with which to share the cluster printing job is obtained.

If the answer at step 18 is NO, the process proceeds to step S19. At step S19, the primary image printing apparatus 1 shares the cluster printing job with at least one candidate printing apparatus. The process then returns to step S9, at which the control CPU 173 in the image processing unit 170 of the primary image printing apparatus 1 determines whether the last page of the cluster printing job has been printed. If the answer is YES, the process proceeds to step S10 where the process is terminated. If the answer at step S9 is NO, the process returns to step S5, and steps S5-S9 are again executed.

According to the above process, the primary image printing apparatus 1 can search over a network for a candidate image printing apparatuses from among a plurality of secondary image printing apparatuses 2 with which to share a cluster printing job. Secondary image printing apparatuses 2 not having the matching paper type information registered in the primary image printing apparatus 1 drop out from being a candidate, and no longer communicate with the primary image printing apparatus 1. Thus, the cluster printing function of the primary image printing apparatus 1 can be performed quickly and efficiently without mixing recording sheets of different types, and the outputted cluster print job can have a uniform finish and appearance.

While the invention has been described with reference to the above embodiments, it is to be understood that the invention is not limited only to the above embodiments or constructions. The invention is intended to cover various modifications and equivalent arrangements. In addition, while the various elements of the above embodiments are shown in various combinations and configurations, that are exemplary, other combinations and configurations, including more, less or only a single element, are also within the spirit and scope of the invention.

What is claimed is:

1. An image printing apparatus comprising:
a memory unit;
an image printing unit which prints an image and has a cluster printing function in which a print job is shared with at least one other printing apparatus over a network;
a registration unit which registers in the memory unit paper type information of a recording sheet to be used in the print job;
a communication unit which transmits and receives image data to and from a plurality of other image printing apparatuses over the network, thereby allowing the image printing apparatus during the cluster printing function to share the print job with at least one of the plurality of other image printing apparatuses over the network, and which receives over the network paper type information of recording sheets in each of the plurality of other image printing apparatuses; and
a determination unit that selects at least one candidate image printing apparatus from among the plurality of other image printing apparatus based whether the paper type information received by the communication unit matches the paper type information registered in the memory unit, wherein
the image printing apparatus, during cluster printing, shares the print job with the at least one candidate image printing apparatus.

2. An image printing apparatus according to claim 1, further comprising a scanning unit which scans a recording sheet to determine a paper type of the recording sheet to be used in the print job, and forwards the paper type information to the registration unit.

3. An image printing apparatus according to claim 1, wherein the paper type determined by the scanning unit is based on at least one of color, brightness and chroma.

4. An image printing apparatus according to claim 1, further comprising a paper feed unit which comprises a plurality of paper feed trays, and allows a selected paper feed tray to feed a recording sheet to the image printing unit.

5. An image printing apparatus according to claim 4, further comprising a sensor associated with each of the plurality of paper feed trays, each sensor determining a paper type of a recording sheet in an associated paper feed tray.

6. An image printing apparatus according to claim 5, wherein the determination unit compares the paper type determined by each sensor with the paper type information registered in the memory unit, and selects a paper feed tray having a paper type matching the paper type information registered in the memory unit as the selected paper feed tray to feed the recording sheet.

7. The image printing apparatus according to claim 6, wherein the determination unit issues an alert if the paper type of the recording sheets in all of the paper feed trays does not match the paper type information registered in the memory unit.

8. An image printing apparatus according to claim 5, wherein each sensor is provided on the associated paper tray.

9. An image printing apparatus according to claim 4, further comprising a sensor provided in a feed path of the recording sheet, the sensor determining a paper type of a recording sheet in the feed path to thereby determine the paper type of recording sheets in the paper feed tray from which the recording sheet was fed.

10. An image printing system comprising:
a network;
a primary image printing apparatus;
a plurality of secondary image printing apparatuses connected to the primary image printing apparatus via the network; and
a cluster printing function in which a print job of the primary image printing apparatus is shared with at least one of the secondary apparatuses over the network, wherein the primary image printing apparatus is controlled to:
register information of a paper type of recording sheets in the primary image printing apparatus;
transmit and receive image data to and from the plurality of secondary image printing apparatuses over the network, and receive paper type information of recording sheets in each of the plurality of secondary image printing apparatuses;
select at least one candidate image printing apparatus from among the plurality of secondary image printing apparatuses based whether the paper type information received from the plurality of secondary image printing apparatuses matches the registered paper type information; and
during cluster printing, share the print job with the at least one candidate image printing apparatus.

11. An image printing system according to claim 10, wherein the registered paper type information is based on at least one of color, brightness and chroma.

12. An image printing system according to claim 10, wherein the primary image printing apparatus comprises a plurality of paper feed trays, one of which is selected to feed a recording sheet.

13. An image printing system according to claim 12, wherein the primary image printing apparatus further comprises a sensor associated with each of the plurality of paper feed trays, each sensor determining a paper type of a recording sheet in an associated paper feed tray.

14. An image printing system according to claim 13, wherein the primary image printing apparatus is controlled to compare the paper type determined by each sensor with the registered paper type information, and select a paper feed tray having a paper type matching the registered paper type information as the selected paper feed tray to feed the recording sheet.

15. The image printing system according to claim 14, wherein the primary image printing apparatus is controlled to issue an alert if the paper type of the recording sheets in all of the paper feed trays does not match the registered paper type information.

16. An image printing method comprising:
determining a paper type of a recording sheet to be used in a print job;
registering paper type information in a memory unit of a primary image printing apparatus;
transmitting image data to a plurality of secondary image printing apparatuses over a network to allow the primary image printing apparatus during a cluster printing function to share the print job with at least one of the plurality of secondary image printing apparatuses over the network;
receiving via the network paper type information of recording sheets in each of the plurality of other image printing apparatuses;
selecting at least one candidate image printing apparatus from among the plurality of secondary image printing apparatus based whether the paper type information received from the plurality of secondary image printing apparatuses matches the paper type information registered in the memory unit of the primary image printing apparatus; and
sharing the print job between the primary image printing apparatus and the at least one candidate image printing apparatus.

17. An image printing method according to claim 16, the registered paper type information being based on at least one of color, brightness and chroma.

18. An image printing method according to claim 16, further comprising selecting one of a plurality of paper feed trays in the primary image printing apparatus to feed a recording sheet.

19. An image printing method according to claim 18, further comprising comparing the paper type determined by each sensor with the paper type information registered in the memory unit, and selecting a paper feed tray having a paper type matching the paper type information registered in the memory unit as the selected paper feed tray to feed the recording sheet.

20. The image printing method according to claim 19, further comprising issuing an alert if the paper type of the recording sheets in all of the paper feed trays does not match the paper type information registered in the memory unit.
